(19) United States
(12) Patent Application Publication
(10) Pub. No.: US 2025/0278697 A1
(43) Pub. Date: Sep. 4, 2025

(54) GENERATING AI-BASED COLLABORATION METHOD AND SYSTEM

(71) Applicant: SAMSUNG SDS CO., LTD., Seoul (KR)

(72) Inventors: Ji Yeon Lee, Seoul (KR); Young Hyun Choi, Seoul (KR); Bo Young Park, Seoul (KR); In Pyo Kim, Seoul (KR)

(73) Assignee: SAMSUNG SDS CO., LTD., Seoul (KR)

(21) Appl. No.: 19/066,840

(22) Filed: Feb. 28, 2025

(30) Foreign Application Priority Data
Feb. 29, 2024 (KR) 10-2024-0030176
May 23, 2024 (KR) 10-2024-0066992

(51) Int. Cl. G06Q 10/101

(52) U.S. Cl. CPC G06Q 10/101

(57) ABSTRACT

Provided is a method performed by at least one computing device. The method comprises receiving a first user request for generating a plurality of participant personas associated with a target problem, from a user terminal, generating the plurality of participant personas associated with the target problem in accordance with the first user request, the plurality of participant personas representing a specialist having work experience in different specialized fields associated with the target problem and generating ideas based on work experience of each of the plurality of participant personas in accordance with a second user request indicating generation of ideas by the plurality of participant personas.

### CROSS-REFERENCE TO RELATED APPLICATIONS

This application claims priority from Korean Patent Application No. 10-2024-0030176 filed on Feb. 29, 2024, and Korean Patent Application No. 10-2024-0066992 filed on May 23, 2024, in the Korean Intellectual Property Office and all the benefits accruing therefrom under 35 U.S.C. 119, the contents of which in its entirety are herein incorporated by reference.

### BACKGROUND

### Technical Field

The present disclosure relates to a generative AI-based collaboration method and system, and more particularly, to a method for generating multiple participant personas by using generative AI and deriving ideas through interaction between participant personas, and a system to which the method is applied.

### Description of the Related Art

Design thinking is a creative problem-solving method that observes and empathizes with humans, defines problems, and repeats prototype and test to find the best answer. According to this method, in order to derive ideas on a specific topic and to perform tests through customer evaluation or feedback for the ideas, the participation of a large number of people with various knowledge and experiences is required.

However, it is difficult to make sure of appropriate manpower according to a specific topic, and there may be a difficulty in communication due to differences in physical distance or time even in case of the appropriate manpower. In addition, there is also a problem that it takes a lot of money and time to select survey items and interviewees for appropriate customer research for services or products. As a result, problems such as project schedule delay, resource waste and quality deterioration may occur.

Generative AI that provides a response according to a user request is being used in various tasks. For example, an idea for a specific topic may be requested using the generative AI, and the idea for the specific topic may be provided as the response according to the request. In this case, when a specific role or experience is set (given) to the generative AI, a more appropriate response may be provided in consideration of the role and experience.

### PRIOR ART REFERENCE

### Patent Reference

U.S. Patent Laid-Open Patent US2020-0342489 (published on Oct. 29, 2020)

### SUMMARY

An object of the present disclosure is to provide a generative AI-based collaboration method and system, in which a collaboration environment between multiple participant personas is implemented using generative AI to overcome limitations of communication due to temporal and spatial constraints.

Another object of the present disclosure is to provide a generative AI-based collaboration method and system, in which interaction between multiple participant personas is implemented considering roles and expertise using generative AI to derive an optimal idea for a given problem based on various backgrounds and experiences.

Other object of the present disclosure is to provide a generative AI-based collaboration method and system, in which ideas may be verified and evaluated through generative AI-based user persona to effectively improve products or services.

The objects of the present disclosure are not limited to those mentioned above and additional objects of the present disclosure, which are not mentioned herein, will be clearly understood by those skilled in the art from the following description of the present disclosure.

According to an aspect of the present disclosure, there is provided method performed by at least one computing device. The method may comprise receiving a first user request for generating a plurality of participant personas associated with a target problem, from a user terminal, generating the plurality of participant personas associated with the target problem in accordance with the first user request, the plurality of participant personas representing a specialist having work experience in different specialized fields associated with the target problem and generating ideas based on work experience of each of the plurality of participant personas in accordance with a second user request indicating generation of ideas by the plurality of participant personas.

In some embodiments, the generating the plurality of participant personas may include: acquiring context information on the target problem, identifying a plurality of specialized fields associated with the target problem based on the context information and generating a participant persona corresponding to each of the identified specialized fields.

In some embodiments, the first user request may include characteristic information for each of the plurality of participant personas, and the generating the plurality of participant personas may include generating the plurality of participant personas in which the characteristic information is preferentially reflected.

In some embodiments, the generating the plurality of participant personas further may include providing characteristic information of the plurality of participant personas to the user terminal, receiving a regeneration request for at least one of the plurality of participant personas from the user terminal; and regenerating at least one of the plurality of participant personas based on the regeneration request.

In some embodiments, the plurality of participant personas may include a first participant persona, and the generating the ideas may include generating a primary idea corresponding to the first participant persona in accordance with the second user request, generating feedback information by the other participant personas except for the first participant persona with respect to the primary idea and generating a secondary idea corresponding to the first participant persona by reflecting the feedback information in the primary idea.

In some embodiments, the generating the ideas may include providing the ideas generated by the plurality of participant personas to the user terminal, receiving a regeneration request for the generated ideas from the user terminal and regenerating the ideas based on the regeneration request.

In some embodiments, the method may further comprise evaluating the generated ideas, selecting an optimal idea based on the evaluated result and visualizing the optimal idea and providing the visualized idea to the user terminal.

In some embodiments, the evaluating the generated ideas may include selecting any one of the plurality of participant personas as an evaluator and grouping the ideas by using the participant persona selected as the evaluator.

In some embodiments, the evaluating the generated ideas may include generating a user persona representing an end user for a service or product associated with the target problem and grouping the ideas by using the generated user persona.

In some embodiments, the evaluating the generated ideas may include performing scoring for the ideas by using the plurality of participant personas.

In some embodiments, the selecting the optimal idea may include calculating an average score according to the scoring for each of the ideas and selecting an idea with a highest average score as the optimal idea.

In some embodiments, the providing the visualized idea to the user terminal may include generating a prototype based on the selected optimal idea.

According to another aspect of the present disclosure, there is provided a system for generative AI-based collaboration. The system may include: one or more processors; and a memory storing one or more computer programs executed by the one or more processors, wherein the one or more computer programs include instructions for: an operation of receiving a first user request for generating a plurality of participant personas associated with a target problem, from a user terminal, an operation of generating the plurality of participant personas associated with the target problem in accordance with the first user request, the plurality of participant personas representing a specialist having work experience in different specialized fields associated with the target problem and an operation of generating ideas based on work experience of each of the plurality of participant personas in accordance with a second user request indicating generation of ideas by the plurality of participant personas.

In some embodiments, the operation of generating the plurality of participant personas may include an operation of acquiring context information on the target problem, an operation of identifying a plurality of specialized fields associated with the target problem based on the context information and an operation of generating a participant persona corresponding to each of the plurality of identified specialized fields.

In some embodiments, the first user request may include characteristic information for each of the plurality of participant personas, and the operation of generating the plurality of participant personas includes an operation of generating the plurality of participant personas in which the characteristic information is preferentially reflected.

In some embodiments, the plurality of participant personas may include a first participant persona, and the operation of generating the ideas includes: an operation of generating a primary idea corresponding to the first participant persona in accordance with the second user request, an operation of generating feedback information by the other participant personas except for the first participant persona with respect to the primary idea and an operation of generating a secondary idea corresponding to the first participant persona by reflecting the feedback information in the primary idea.

In some embodiments, the one or more computer programs may further include instructions for: an operation of evaluating the generated ideas, an operation selecting an optimal idea based on the evaluated result and an operation of visualizing the optimal idea and providing the visualized idea to the user terminal.

In some embodiments, the operation of evaluating the generated ideas may include an operation selecting any one of the plurality of participant personas as an evaluator and an operation of grouping the ideas by using the participant persona selected as the evaluator.

In some embodiments, the operation of evaluating the generated ideas may include an operation of generating a user persona representing an end user for a service or product associated with the target problem and an operation of grouping the ideas by using the generated user persona.

In some embodiments, the operation of evaluating the generated ideas may include an operation of performing scoring for the ideas by using the plurality of participant personas.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary view illustrating an overall configuration of a generative AI-based collaboration system according to some embodiments of the present disclosure;

FIG. 2 is a flow chart illustrating a generative AI-based collaboration method according to some embodiments of the present disclosure;

FIGS. 3 to 5 are exemplary views illustrating a partial operation shown in FIG. 2;

FIG. 6 is a flow chart illustrating operations that may be performed following the operations described with reference to FIG. 2;

FIGS. 7 to 9b are exemplary views illustrating a partial operation shown in FIG. 6; and

FIG. 10 is a block diagram illustrating a hardware configuration of a computing system for performing a generative AI-based collaboration method according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

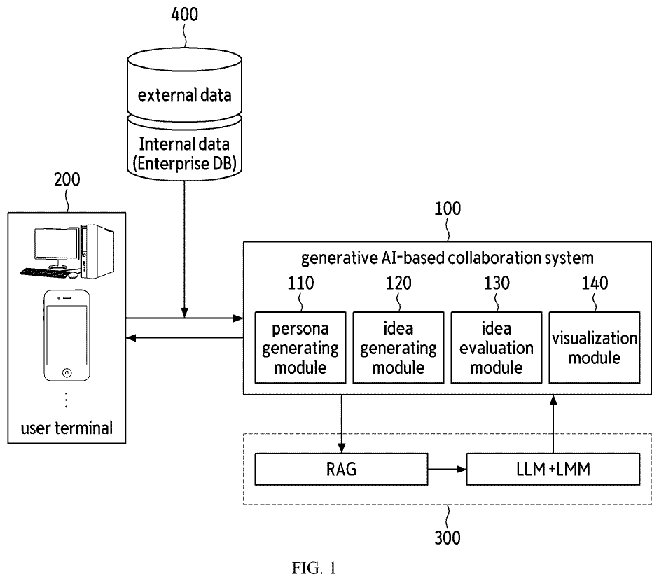

FIG. 1 is an exemplary view illustrating an overall configuration of a generative AI-based collaboration system according to some embodiments of the present disclosure.

As shown in FIG. 1, a generative AI-based collaboration system 100 according to some embodiments of the present disclosure may implement a generative AI-based collaboration method according to some embodiments of the present disclosure through interaction with a user terminal 200, a generative model 300 and a knowledge base 400.

A user may input a user request to be transmitted to the generative AI-based collaboration system 100 through the user terminal 200, that is, through a user interface provided by the generative AI-based collaboration system 100. The user interface may include both a graphic user interface such as a search window and a dialog box for requesting a generative AI service of a user query and an application interface such as a Rest API. In this case, the user request may be a prompt configured in various forms such as text, voice, image and video.

The generative model 300 may include a large language model (LLM) with natural language (text) understanding and generation capabilities, and a vison language model (or a large multimodal model (LMM) with image understanding capabilities, and may further include understanding capabilities for other models. The generative model may be a model developed by itself or a model provided from the outside. In some cases, the generative model may be referred to as a ‘language model (LM), a ‘large language model (LLM), a ‘generative language/deep learning model’, or a ‘generative artificial intelligence (AI) model’.

In one embodiment, the generative AI-based collaboration system 100 may provide a response according to a user request in connection with the generative model 300. For example, a participant persona may be generated in accordance with a user request for generating a participant persona, and an idea may be generated in accordance with a user request for generating an idea. In the present disclosure, the response provided by the participant persona or the user persona may be understood as a response generated through the generative model 300 based on characteristic information of each persona.

In one embodiment, the generative AI-based collaboration system 100 may inquire information necessary for generating a response according to a user request in the knowledge base 400. The knowledge base 400 may be configured by combination of an internal database that stores internal information of an institution that operates the generative AI-based collaboration system 100 and an external database.

Hereinafter, a configuration and function of a generative AI-based collaboration system 100 according to one embodiment of the present disclosure will be described in detail.

The generative AI-based collaboration system 100 according to one embodiment of the present disclosure may include a persona generating module 110, an idea generating module 120, an idea evaluation module 130, and a visualization module 140. However, the components shown in FIG. 1 do not reflect all functions of the generative AI-based collaboration system 100 and are not essential, and thus the generative AI-based collaboration system 100 may include more or fewer components than the shown components.

In addition, the components of the generative AI-based collaboration system 100 shown in FIG. 1 represent functionally distinct functional elements, and multiple components may be implemented to be integrated with each other in an actual physical environment, or a specific component may be implemented to be separated into multiple sub-components.

The persona generating module 110 may perform a function of generating a plurality of participant personas associated with a target problem in accordance with a first user request for generating the plurality of participant personas associated with the target problem. In detail, the persona generating module 110 may generate the plurality of participant personas in a way of acquiring context information on the target problem, identifying a plurality of specialized fields associated with the target problem based on the context information, and setting (defining) characteristic information of participant personas respectively corresponding to the identified plurality of specialized fields. In this case, when the characteristic information of the participant personas is included in the user request, a participant persona in which the characteristic information is preferentially reflected may be generated.

In addition, the persona generating module 110 may perform a function of generating a user persona representing an actual user of a product or service related to the target problem. The persona generating module 110 may set (define) characteristic information of the user persona in accordance with a user request for generating the user persona, and the user persona may provide a response to the user request based on the set characteristic information.

The idea generating module 120 may perform a function of generating an idea based on work experience of each if the plurality of participant personas. When a second user request for instructing to generate an idea by the plurality of participant personas is input, the idea generating module 120 may configure a prompt based on the second user request and the characteristic information of each of the plurality of participant personas. As a result, a plurality of ideas may be generated based on the characteristic information of the plurality of participant personas.

The idea evaluation module 130 may perform a function of evaluating the generated idea. In detail, the generated idea may be grouped in accordance with association, similarity, and the like to generate an idea group, and scoring for the idea group may be performed to select an optimal idea. In this case, the idea may be evaluated in view of the plurality of personas or the user persona in accordance with the request of the user. This will be described later in detail.

The visualization module 140 may perform a function of visualizing an optimal idea and providing the visualized idea to a user terminal. The user may check the visualized idea through the user terminal, and may modify and improve the idea through evaluation and feedback.

Although FIG. 1 illustrates that the persona generating module 110, the idea generating module 120, the idea evaluation module 130 and the visualization module 140 perform an operation associated with one generative model 300, the present disclosure is not necessarily limited to this example. That is, the persona generating module 110, the idea generating module 120, the idea evaluation module 130 and the visualization module 140 may perform some of the processing processes according to the user's request by using different generative models corresponding to the respective modules.

The configuration and operation of the AI-based collaboration system 100 according to some embodiments of the present disclosure have been described with reference to FIG. 1. The embodiments described above will be understood in more detail with reference to other embodiments that will be described later. In addition, the technical spirits that may be understood through the above-described embodiments may be applied to other embodiments that will be described later, although not specified separately.

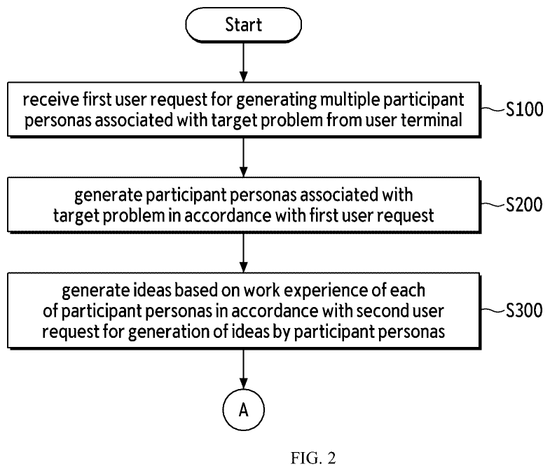

Hereinafter, a generative AI-based collaboration method according to another embodiment of the present disclosure will be described with reference to FIGS. 2 to 9. It is to be understood that steps to be described in some flow charts below are performed by the generative AI-based collaboration system 20 described with reference to FIG. 1 unless otherwise mentioned. However, for convenience of description, an operation subject of each step may be omitted.

FIG. 2 is a flow chart illustrating a generative AI-based collaboration method according to some embodiments of the present disclosure. However, this is only a preferred embodiment for achieving the object of the present disclosure, and some steps may be added or deleted as necessary.

As illustrated in FIG. 2, the generative AI-based collaboration method according to one embodiment of the present disclosure may be initiated in step $100 of receiving a first user request for generating a plurality of participant personas associated with a target problem from a user terminal. In detail, the user may input a first user request for requesting (instructing) to generate a plurality of participant personas associated with the target problem along with a description of the target problem to be solved through the user terminal, and the first user request may be transmitted to the persona generating module 110 of the AI-based collaboration system 100. In this case, the first user request may include various types of data such as text, voice, image and video. The first user request may be input in the form of text, for example, “I want to improve the meeting system, please generate a participant persona for this.” or “I want to improve the manufacturing system, please generate a participant persona to discuss this.”

In one embodiment, the first user request may include characteristic information on each participant persona to be generated. In detail, the user may specifically define/set characteristic information (e.g., age, gender, occupation, career period, specialized field, interest, etc.) of a plurality of participant personas to be generated while instructing (requesting) generation of a plurality of participant personas to be generated, and accordingly, a participant persona that reflects the needs of the user may be generated.

Next, in step S200, the plurality of participant personas associated with the target problem may be generated in accordance with the first user request. In this case, the plurality of participant personas may represent experts having work experience in different specialized fields associated with the target problem.

In detail, the persona generating module 110 may configure/generate a first prompt for generating a plurality of participant personas based on a first user request, context information on a target problem, and the like, and may generate a plurality of participant personas by inputting the generated first prompt to the generative model 300. To this end, the context information on the target problem may be acquired.

The context information on the target problem may include a cause of the target problem, an issue (e.g., a history of occurrence of a problem associated with the target problem, etc.) related to the target problem, voice of customer (VoC) information (e.g., customer feedback, customer requirements, customer satisfaction survey information) associated with the target problem, keywords related to the target problem, and a project history related to the target problem, but the present disclosure is not limited thereto. When there is any information that may help to understand and define the target problem more accurately, the corresponding information may be acquired as the context information on the target problem.

In more detail, when the first prompt is input to the generative model 300, a plurality of specialized fields associated with the target problem may be identified, and characteristic information of the participant persona may be set (defined) in consideration of characteristics of each of the plurality of identified specialized fields, a relation with the target problem, a role expected in relation to the target problem, and the like. The characteristic information of the participant persona may include demographic information (e.g., age, gender, educational background, income level, educational level, etc.), professional information of a specific industry field (e.g., finance, medical care, manufacturing, logistics, service, etc.), and work experience information related to the target problem. Accordingly, a plurality of participant personas representing experts having related work experience in a plurality of specialized fields may be generated. That is, the plurality of participant personas associated with the target problem may be automatically generated without a detailed user input for the characteristic information of the participant persona.

As described above, the first user request for generating the plurality of participant personas may include characteristic information defining each characteristic and attribute of the participant personas, and in this case, a plurality of participant personas in which the input characteristic information is preferentially reflected may be generated. To this end, a screen indicating a detailed item of characteristic information of a participant persona to be defined (set) may be provided. Also, according to one embodiment, when characteristic information input by the user is not clear or detailed, a query for acquiring detailed characteristic information may be generated. This will be described later.

The step S200 of generating a plurality of participant personas may further include providing characteristic information of the generated plurality of participant personas to the user terminal, receiving a regeneration request for at least one of the plurality of personas from the user terminal, and regenerating at least one of the plurality of personas based on the regeneration request. That is, when the first generated participant persona does not meet the user's needs or is not suitable for the target problem, some or all of the plurality of participant personas generated in response to the user's regeneration request may be regenerated. In this case, regeneration may be performed for a specific item among items constituting the characteristic information of the plurality of participant personas. For example, when the user inputs a regeneration request, such as “Change the career period of A participant persona”, and “Add work experience of participating in a meeting system improvement project to the A participant persona”, only a specific item may be changed or modified in accordance with the regeneration request. That is, it should be understood that regenerating the participant persona includes modifying, changing or deleting some items of the characteristic information of the generated participant persona.

Next, in step S300, an idea may be generated based on work experience of each of the plurality of participant personas in accordance with a second user request for generating an idea by the plurality of participant personas. The user may input a second user request for requesting (instructing) to generate an idea through the user terminal, and the second user request may be transmitted to the idea generating module 120 of the AI-based collaboration system 100. In this case, the second user request may include information such as a subject of an idea, a participant persona to be requested, and the number of ideas.

In more detail, the idea generating module 120 may configure/generate a second prompt based on a second user request, characteristic information of each of participant personas, and the like, and may generate an idea based on characteristic information including work experience of each of the plurality of participant personas by inputting the generated second prompt to the generative model 300. In this case, learning based on data related to the target problem may be preceded (that is, a learning range is selected in consideration of the target problem). As a result, a single participant persona team capable of sharing thoughts on one target problem and performing collaboration together may be formed.

In one embodiment, an idea reflecting feedback information by interaction between the plurality of participant personas may be generated. For example, when a primary idea corresponding to a first participant persona is generated in accordance with the second user request, evaluation such as an opinion presented by the other participant personas except for the first participant persona may be performed for the primary idea, and a secondary idea may be generated by reflecting such feedback information.

The step S300 of generating an idea may further include providing an idea generated by a plurality of participant personas to a user terminal, receiving a regeneration request for the idea generated by the user terminal, and regenerating the idea based on the regeneration request. That is, the user may check the ideas generated by the plurality of participant personas through the user terminal, and may determine appropriateness such as whether each idea meets the user's needs or whether each idea is associated with the target problem. In addition, when there is an idea that is determined to be inappropriate as a result of the determination of appropriateness, a regeneration request indicating regeneration of the idea may be input to the user terminal.

Although it has been described that the appropriateness of the idea generated by the user is determined, the appropriateness of the idea generated through the generative model may be determined depending on the embodiment. In detail, each idea information generated in the step S300 and a prompt for querying about the appropriateness of the idea information may be input to the generative model 300, and the appropriateness of the idea may be determined through the generative model 300.

Hereinafter, the generative AI-based collaboration method according to the present embodiment will be described in more detail with reference to detailed embodiments.

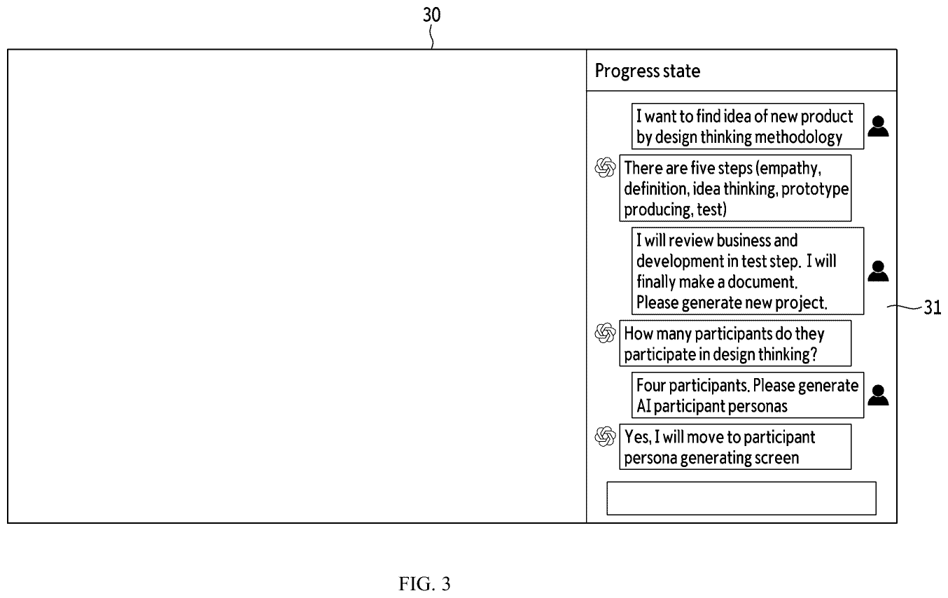

FIGS. 3 to 5 are exemplary views illustrating a partial operation shown in FIG. 2. In more detail, as an example of a user request input by a user and examples of screens 30, 40 and 50 provided to the user terminal in response to the user request are illustrated in FIGS. 3 to 5.

FIG. 3 exemplarily illustrates an initial screen.

As shown in FIG. 3, a screen 30 provided by a generative AI-based

collaboration system may include a chat region and a board region. The chat region may be a region in which a user request is input and interaction between a user and generative AI may be checked. The board region may be a region for visually providing a result according to the input user request.

In order to initiate collaboration for one target problem in accordance with the present embodiment, the user may instruct (request) to generate a plurality of participant personas associated with the target problem (“generate four AI participant personas) while presenting the target problem in a prompt input region of the chat region (“I want to find an idea for a new product by using the design thinking methodology”). In this case, the participant personas may be generated in accordance with a first method based on an automatic recommendation or a second method based on a user input.

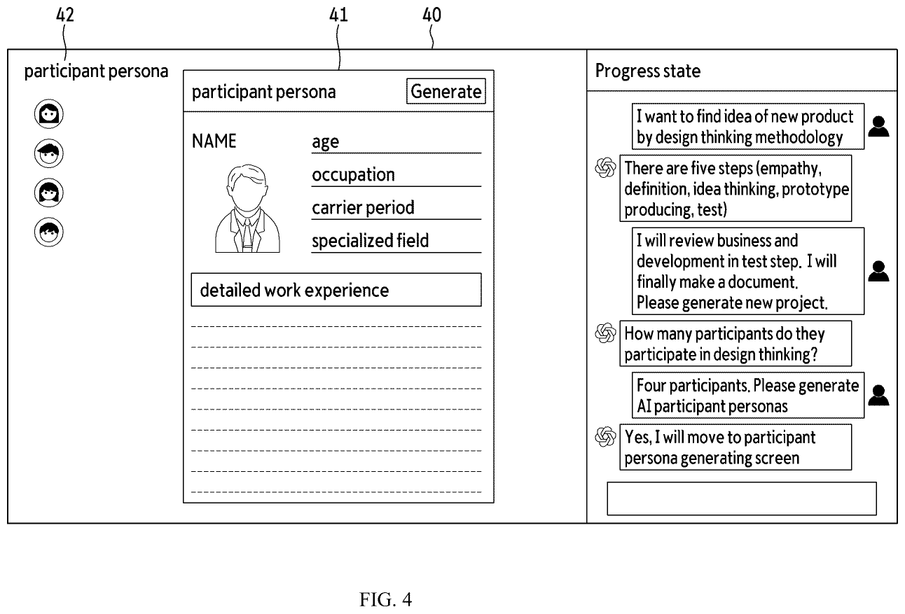

FIG. 4 exemplarily illustrates a screen in the process of generating a participant persona according to the user request illustrated in FIG. 3.

First, the process of generating a participant persona according to the first method will be described. Four specialized fields for finding an idea of a new product may be identified in accordance with the user request, and characteristic information of the participant persona may be set (defined) in consideration of each characteristic of the plurality of identified specialized fields, a relation with a target problem, a role expected in relation to the target problem, and the like. That is, according to the method of generating a participant persona according to the first method, a participant persona related to the target problem may be automatically generated even without a detailed input of characteristic information of the participant persona.

Next, the process of generating a participant persona according to the second method will be described. A user may specifically input a characteristic and an attribute of a participant persona that the user wants to generate in the prompt input region, and the participant persona may be generated based on the input information. In this case, a participant persona generating screen 41 indicating a detailed item of characteristic information of the participant persona may be provided. The user may check items (age, occupation, career period, and specialized field) of characteristic information displayed on the participant persona generating screen 41 and input information on each item, thereby generating a participant persona having characteristic information that meets the user's needs.

The method of generating a participant persona according to the first method and the method of generating a participant persona according to the second method may be applied in combination. That is, some of the plurality of participant personas may be generated in accordance with the first method, and the other some of the plurality participant personas may be generated in accordance with the second method.

When the participant persona is generated in accordance with the above method, as illustrated in FIG. 4, an icon 42 indicating all participant personas may be displayed in one region of the board region, and when the icon is selected, a screen indicating characteristic information of the corresponding participant persona may be displayed. Accordingly, the user may immediately check and compare detailed characteristic information of the generated participant personas, and may determine and evaluate whether the generated participant personas are appropriate.

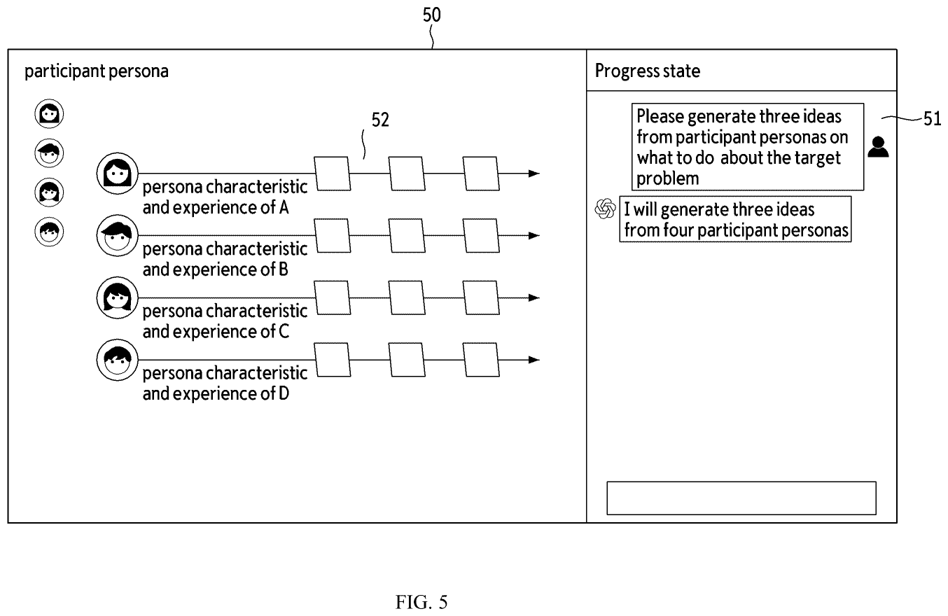

FIG. 5 exemplarily illustrates a screen in the process of generating an idea.

The user may input a request for generating an idea by specifying a request target persona, the number of ideas, etc. in the prompt input region, like “Please generate three ideas from participant personas on what to do about the target problem.” Accordingly, the generated ideas may be displayed on the board region by being converted into visual information (52). As a result, the user may easily check an idea corresponding to each participant persona.

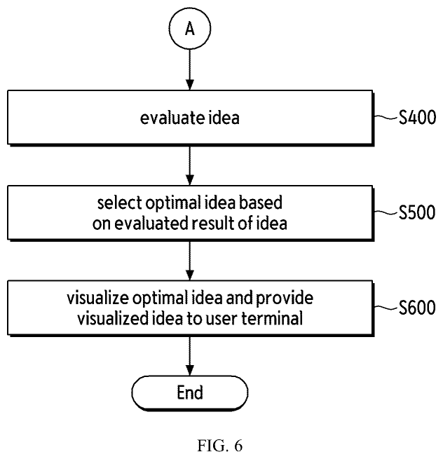

The operations of generating a plurality of participant personas associated with a target problem and generating an idea based on work experience of each of the plurality of participant personas have been described with reference to FIGS. 2 to 5. According to another embodiment of the present disclosure, the idea generated in accordance with the operations may be visualized through operations, which will be described later, and may be provided to the user terminal. Hereinafter, operations, which may be performed following the operations described with reference to FIG. 2, will be described with reference to FIGS. 6 to 9.

FIG. 6 is a flow chart illustrating operations that may be performed following the operations described with reference to FIG. 2.

First, the evaluation of the ideas generated by the plurality of participant personas may be performed (S400). The operation of evaluating the idea may include grouping the generated ideas in accordance with correlation and scoring an idea group or an individual idea. In this case, the operation of evaluating the idea may be performed by the idea evaluation module 130 of the AI-based collaboration system 100.

First, the operation of grouping the generated ideas in accordance with correlation will be described.

According to one embodiment, the ideas generated by the plurality of participant personas may be grouped using any one of the plurality of participant personas. In detail, when a user input for selecting any one of the plurality of participant personas as an evaluator is received, the ideas may be classified by the participant persona selected as an evaluator. In this case, grouping the ideas by the participant persona selected as an evaluator (or by using the participant persona selected as an evaluator) may mean identifying/classifying related ideas in accordance with a criterion set in view of the participant selected as an evaluator, and grouping the related ideas to generate an idea group. In this case, redundant ideas may be removed.

In one embodiment, the ideas generated by the plurality of participant personas may be grouped by a user persona. In this case, the user persona represents an end user for a service or product related to the target problem. In addition, grouping ideas by the user persona may mean identifying/classifying related ideas in accordance with a criterion set in view of the user persona and grouping the related ideas to generate an idea group. The user persona may be generated in accordance with the method of generating a participant persona according to the previous embodiment. This will be described later in detail.

The grouping of ideas may include regrouping the ideas based on a user's request or feedback information of a plurality of persona users. For example, a detailed description related to grouping such as an idea group generated by grouping, a grouping criterion and a reason for setting a grouping criterion may be provided to the user terminal. When the user determines that grouping is not appropriate after checking the detailed description, the user may request regrouping through the user terminal, and regrouping may be performed in accordance with the regrouping request. In another example, feedback information (analysis, opinion) for grouping may be generated by each of the plurality of participant personas, and regrouping may be performed based on the feedback information.

Next, the operation of performing scoring for an idea group or individual idea will be described.

In one embodiment, when a user request for scoring using a plurality of participant personas is input for an idea group or an individual idea, scoring for the idea group or the individual idea may be performed based on work experience corresponding to each of the plurality of participant personas, and a score according to the scoring may be generated. In this case, an average score of scores corresponding to each of the idea group or the individual idea may be calculated.

In one embodiment, when a user request for scoring using a user persona is input for an idea group or an individual idea, scoring for the idea group or the individual idea may be performed based on characteristic information of the user persona, and a score according to the scoring may be generated. The user persona represents an end user for a service or product associated with the target problem.

In step S500, an optimal idea may be selected based on the idea evaluation result. In one embodiment, an idea (or an idea group) having a highest score (or highest average score) according to scoring may be selected as the optimal idea.

Next, in step S600, the optimal idea may be visualized and provided to the user terminal. In detail, the optimal idea selected in step S500 may be transferred to the visualization module 140 of the AI-based collaboration system 100, and the visualization module 140 may generate a prototype based on the optimal idea in conjunction with the generative model 300 and provide the generated prototype to the user terminal. In this case, the user may check the generated prototype through the user terminal and request modification of some or all of the prototype, and the visualization module 140 may perform a modification operation for the prototype in accordance with the user's modification request by using object detection and a segmentation model (e.g., segment anything model, object detection model, etc.), and may provide the modified version of the prototype to the user terminal.

Hereinafter, a generative AI-based collaboration method according to the present embodiment will be described in more detail with reference to detailed embodiments.

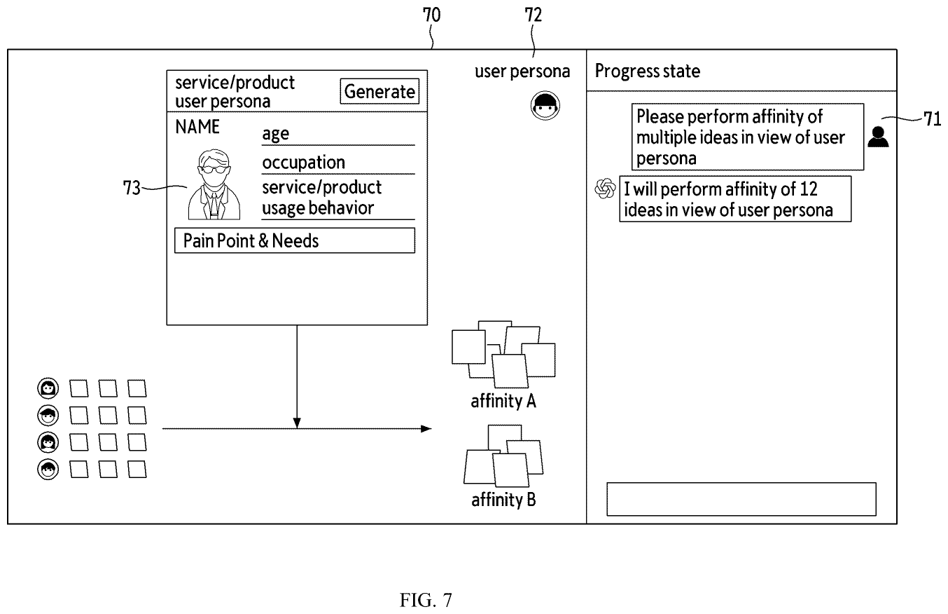

FIGS. 7 to 9 are exemplary views illustrating a partial operation shown in FIG. 6. In more detail, an example of a user request input by a user and an example of screens 70, 80 and 90 provided to the user terminal in response to the user request are illustrated in FIGS. 7 to 9.

FIG. 7 exemplarily illustrates the screen 70 in the process of grouping the generated idea.

As illustrated in FIG. 7, when a user request 71 for grouping ideas is input like “perform affinity multiple ideas in view of a user persona,” ideas generated by multiple participant personas may be grouped in accordance with the user request.

In this case, generation of a user persona for performing grouping may be preceded. Like generation of a participant persona, a user persona may be generated in accordance with the first method based on automatic recommendation or the second method based on a user input. In detail, according to the first method, characteristic information of the user persona is automatically set (defined) in accordance with a user request for generating the user persona without a detailed input for the characteristic information of the user persona, and thus the user persona representing an end user for a service or product associated with a target problem may be generated. On the other hand, according to the second method, a user persona in which characteristic information input by a user is preferentially reflected may be generated. In this case, the characteristic information of the user persona may include demographic information (e.g., age, gender, educational background, income level, educational level, residential area, etc.), and information such as personality type (MBTI), experience of using a service or product, brand, intimacy with a product, digital behavior and social media activities, consumption propensity, shopping habits, technical preference, and capability. When the user persona is generated in accordance with the above generating method, as illustrated in FIG. 7, an icon 72 indicating the user persona may be displayed in one region of the board region, and when the icon is selected, a screen indicating the characteristic information of the user persona may be displayed.

Subsequently, grouping for a plurality of generated ideas may be performed by the user persona, that is, in accordance with a criterion set based on the characteristic information of the user persona, and the grouping result may be provided to the board region in the form of an affinity diagram (affinity A and affinity B). In this case, a detailed description of the grouping criterion may be provided together, and accordingly, the user may easily check and evaluate the grouping result.

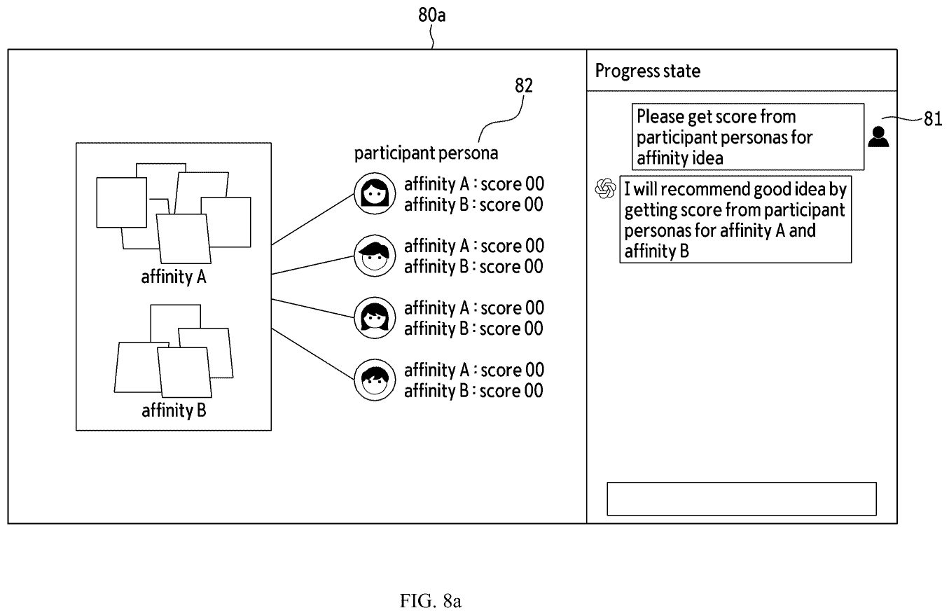

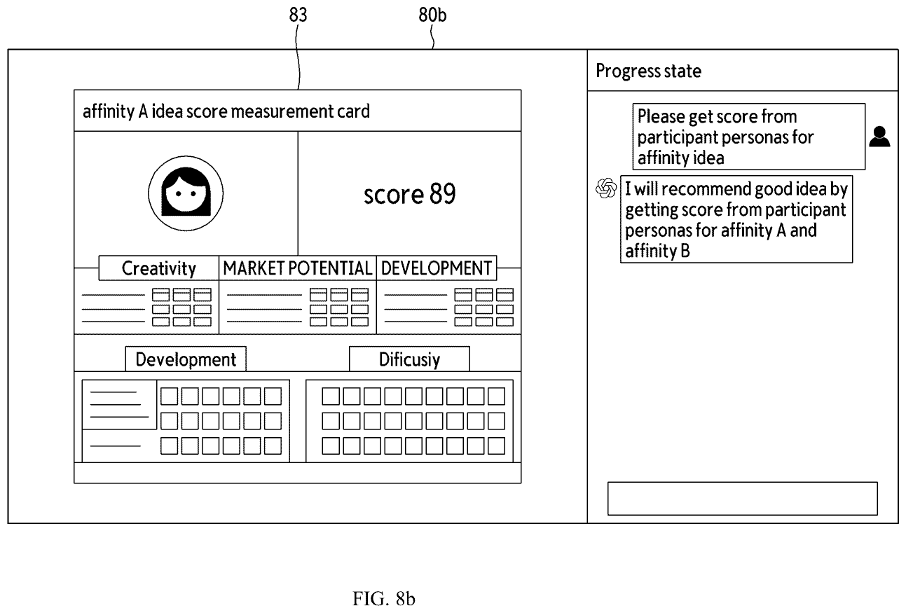

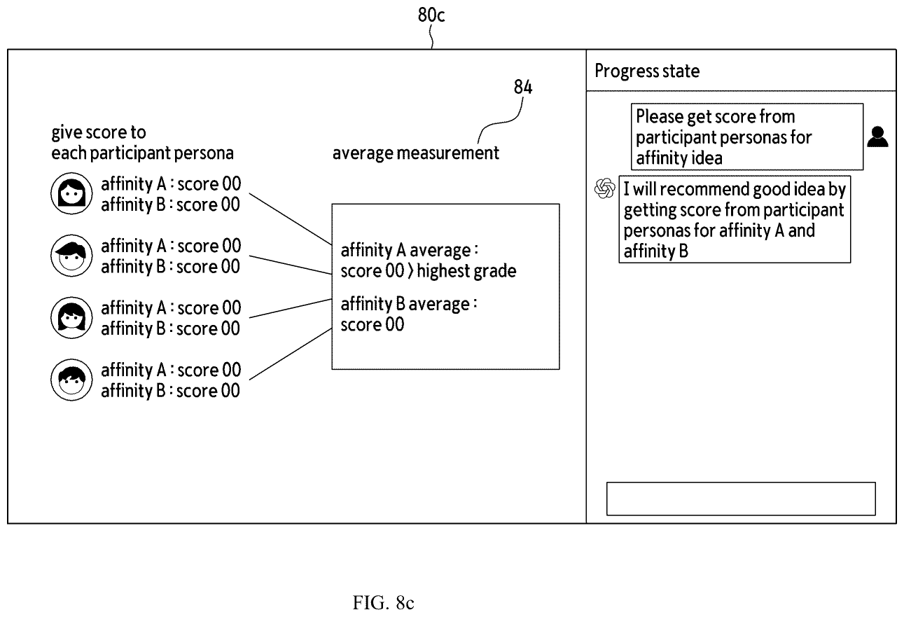

FIGS. 8a to 8c exemplarily illustrate screens 80a, 80b and 80c in the process of performing scoring for the grouped idea group in the example of FIG. 7.

Referring to FIG. 8a, when a user request 81 for instructing (requesting) to perform scoring, “Take a score from participant personas for ideas subjected to affinity” is input, the plurality of participant personas may assign a score to each idea (idea group) subjected to affinity based on their respective work experience (82).

In this case, as shown in FIG. 8b, a detailed reason for the score presented by each participant persona may be identified. In detail, a scoring item may be defined based on characteristic information that includes work experience of each participant persona, and a screen 80b including detailed contents (scoring content, scoring basis, etc.) of each defined item may be provided. In this case, a paper corresponding to the scoring basis and related URL information may be presented together.

Subsequently, as illustrated in FIG. 8c, an average of scores assigned to each affinity may be calculated, and a screen 80c indicating a result 84 of comparing the calculated average may be provided. In this case, according to the embodiment, an idea group having the highest average score may be selected as an optimal idea.

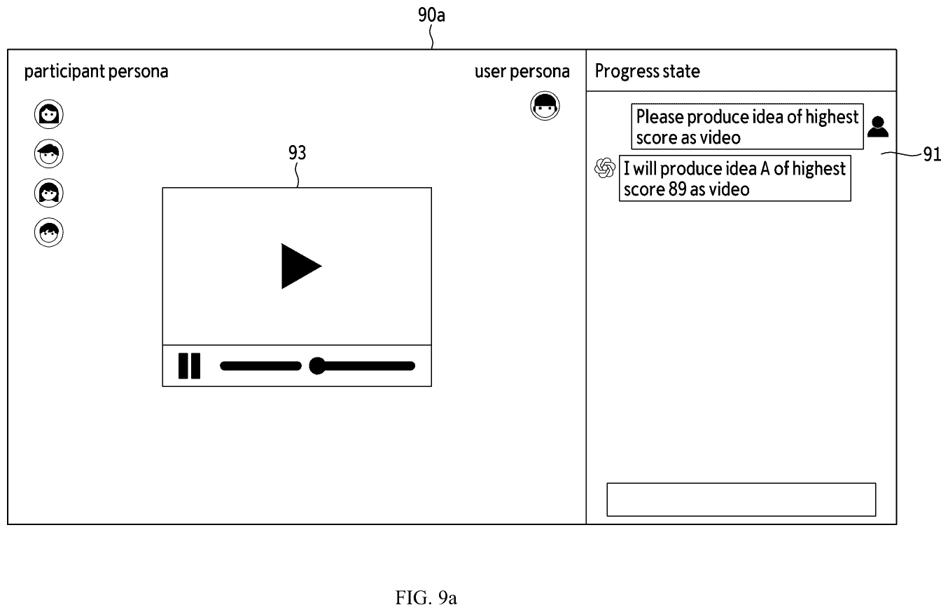

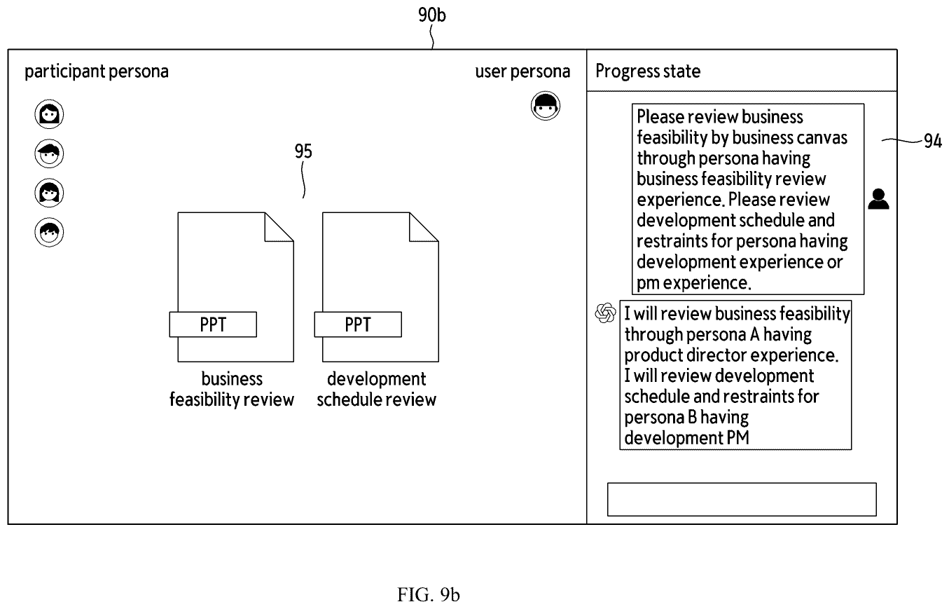

FIGS. 9a and 9b exemplarily illustrate screens 90a and 90b provided in the process of visualizing the optimal idea group selected in the example of FIG. 8.

As shown in FIG. 9a, when a user request 91 for requesting visualization of the idea, like “Please make an idea with the highest score into a video,” is input, a screen 90a displaying an image (prototype) 93 generated based on the idea may be provided. In addition, when a user request 94 for requesting additional review of the visualized idea is input, as illustrated in FIG. 9b, a screen 90b on which a result (e.g., a business feasibility review result, a development schedule review result, etc.) according to an additional review request is displayed may be provided.

The generative AI-based collaboration method according to some embodiments of the present disclosure has been described with reference to FIGS. 2 to 9. According to the embodiments of the present disclosure, an optimal idea for the target problem may be derived through a process of generating and evaluating an idea for the target problem through a plurality of participant personas, and furthermore, a prototype for the optimal idea may be generated and an immediate feedback therefor may be performed.

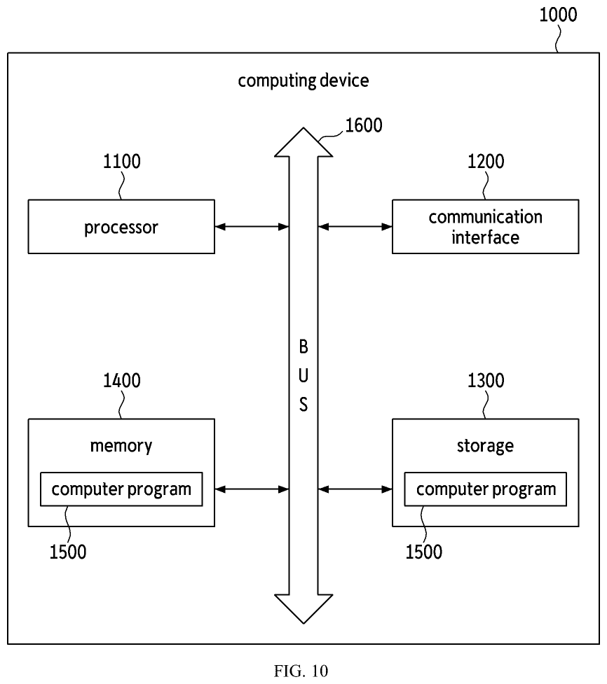

FIG. 10 is a block diagram illustrating a hardware configuration of a computing system for performing a generative AI-based collaboration method according to some embodiments of the present disclosure.

Referring to FIG. 10, a computing system 1000 may include one or more processors 1100, a system bus 1600, a communication interface 1200, a memory 1400 for loading a computer program 1500 performed by the processor 1100, and a storage 1300 for storing the computer program 1500. In FIG. 11, only components related to the embodiments of the present disclosure are shown. Accordingly, it may be apparent to those skilled in the art that other general components in addition to the components shown in FIG. 10 may be further included in the computing system 1000. That is, the computing system 1000 may further include various components in addition to the components shown in FIG. 10. In addition, in some cases, the computing system 1000 may be configured in a form in which some of the components shown in FIG. 10 are omitted. Hereinafter, each component of the computing system 1000 will be described.

The processor 1100 may control the overall operation of each component of the computing system 1000. The processor 1100 may be configured to include at least one of a Central Processing Unit (CPU), a Micro Processor Unit (MPU), a Micro Controller Unit (MCU), a Graphic Processing Unit (GPU), or any type of processor well known in the art of the present disclosure. In addition, the processor 1100 may perform computation for at least one application or program for executing specific operations/methods. The computing system 1000 may include two or more processors.

The memory 1400 may store various types of data, commands and/or information. The memory 1400 may load one or more programs 1500 from the storage 1300 to execute the operations/methods according to the embodiments of the present disclosure. The memory 1400 may be implemented as a nonvolatile memory such as a RAM, but the technical scope of the present disclosure is not limited thereto.

Next, the system bus 1600 provides a communication function between components of the computing system 1000. The system bus 1600 may be implemented as various types of buses such as an address bus, a data bus, and a control bus.

The communication interface 1200 may support wired/wireless Internet communication of the computing system 1000. The communication interface 1200 may support various communication methods other than Internet communication. To this end, the communication interface 1200 may be configured to include a communication module well known in the art of the present disclosure.

The storage 1300 may non-temporarily store one or more computer programs 1500. The storage 1300 may include a nonvolatile memory such as a read only memory (ROM), an Erasable Programmable ROM (EPROM), an Electrically Erasable Programmable ROM (EEPROM) and a flash memory, a hard disk, a detachable disk, or any type of computer-readable recording medium well known in the art to which the present disclosure pertains.

The computer program 1500 may include one or more instructions to allow the processor 1100 to perform specific steps/operations/methods. That is, the processor 1100 may perform specific steps/operations/methods by executing one or more instructions.

For example, the computer program 1500 may include instructions for an operation of receiving a first user request for generating a plurality of participant personas associated with a target problem from a user terminal, and an operation of generating the plurality of participant personas associated with the target problem in accordance with the first user request, the plurality of participant personas representing a specialist having work experience in different specialized fields associated with the target problem, and an operation of generating an idea based on work experience of each of the plurality of participant personas in accordance with a second user request indicating generation of ideas by the plurality of participant personas.

In some embodiments, the computing system 1000 shown in FIG. 10 may mean a virtual machine implemented based on cloud technology. For example, the computing system 1000 may be a virtual machine that operates on one or more physical servers included in a server farm. In this case, at least a portion of the processor 1100, the memory 1400 and the storage 1300 among the components shown in FIG. 10 may be virtual hardware, and the communication interface 1200 may be also implemented as a virtualized networking elements such as a virtual switch.

Various embodiments of the present disclosure and effects according to the embodiments have been mentioned with reference to FIGS. 1 to 10. The effects according to the technical spirits of the present disclosure are not limited to the above-mentioned effects, and other effects not mentioned will be clearly understood by those skilled in the art from the following description.

Furthermore, although a plurality of components have been described as being combined into one or operated in combination in the above embodiments, the technical spirits of the present disclosure are not necessarily limited thereto. That is, all of the components may operate to be selectively combined in one or more within the purpose scope of the technical spirits of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A generative AI-based collaboration method performed by at least one computing device, the generative AI-based collaboration method comprising:
receiving a first user request for generating a plurality of participant personas associated with a target problem, from a user terminal;
generating the plurality of participant personas associated with the target problem in accordance with the first user request, the plurality of participant personas representing a specialist having work experience in different specialized fields associated with the target problem; and
generating ideas based on work experience of each of the plurality of participant personas in accordance with a second user request indicating generation of ideas by the plurality of participant personas.

2. The generative AI-based collaboration method of claim 1, wherein the generating the plurality of participant personas includes:
acquiring context information on the target problem;
identifying a plurality of specialized fields associated with the target problem based on the context information; and
generating a participant persona corresponding to each of the identified specialized fields.

3. The generative AI-based collaboration method of claim 1, wherein the first user request includes characteristic information for each of the plurality of participant personas, and
the generating the plurality of participant personas includes generating the plurality of participant personas in which the characteristic information is preferentially reflected.

4. The generative AI-based collaboration method of claim 1, wherein the generating the plurality of participant personas further includes:
providing characteristic information of the plurality of participant personas to the user terminal;
receiving a regeneration request for at least one of the plurality of participant personas from the user terminal; and
regenerating at least one of the plurality of participant personas based on the regeneration request.

5. The generative AI-based collaboration method of claim 1, wherein the plurality of participant personas include a first participant persona, and
the generating the ideas includes:
generating a primary idea corresponding to the first participant persona in accordance with the second user request;
generating feedback information by the other participant personas except for the first participant persona with respect to the primary idea; and
generating a secondary idea corresponding to the first participant persona by reflecting the feedback information in the primary idea.

6. The generative AI-based collaboration method of claim 1, wherein the generating the ideas includes:
providing the ideas generated by the plurality of participant personas to the user terminal;
receiving a regeneration request for the generated ideas from the user terminal; and
regenerating the ideas based on the regeneration request.

7. The generative AI-based collaboration method of claim 1, further comprising:
evaluating the generated ideas;
selecting an optimal idea based on the evaluated result; and
visualizing the optimal idea and providing the visualized idea to the user terminal.

8. The generative AI-based collaboration method of claim 7, wherein the evaluating the generated ideas includes:
selecting any one of the plurality of participant personas as an evaluator; and
grouping the ideas by using the participant persona selected as the evaluator.

9. The generative AI-based collaboration method of claim 7, wherein the evaluating the generated ideas includes:
generating a user persona representing an end user for a service or product associated with the target problem; and
grouping the ideas by using the generated user persona.

10. The generative AI-based collaboration method of claim 7, wherein the evaluating the generated ideas includes performing scoring for the ideas by using the plurality of participant personas.

11. The generative AI-based collaboration method of claim 10, wherein the selecting the optimal idea includes:
calculating an average score according to the scoring for each of the ideas; and
selecting an idea with a highest average score as the optimal idea.

12. The generative AI-based collaboration method of claim 7, wherein the providing the visualized idea to the user terminal includes generating a prototype based on the selected optimal idea.

13. A generative AI-based collaboration system comprising:
one or more processors; and
a memory storing one or more computer programs executed by the one or more processors,
the one or more computer programs include instructions for:
an operation of receiving a first user request for generating a plurality of participant personas associated with a target problem, from a user terminal;
an operation of generating the plurality of participant personas associated with the target problem in accordance with the first user request, the plurality of participant personas representing a specialist having work experience in different specialized fields associated with the target problem; and
an operation of generating ideas based on work experience of each of the plurality of participant personas in accordance with a second user request indicating generation of ideas by the plurality of participant personas.

14. The generative AI-based collaboration system of claim 13, wherein the operation of generating the plurality of participant personas includes:
an operation of acquiring context information on the target problem;
an operation of identifying a plurality of specialized fields associated with the target problem based on the context information; and
an operation of generating a participant persona corresponding to each of the plurality of identified specialized fields.

15. The generative AI-based collaboration system of claim 13, wherein the first user request includes characteristic information for each of the plurality of participant personas, and
the operation of generating the plurality of participant personas includes an operation of generating the plurality of participant personas in which the characteristic information is preferentially reflected.

16. The generative AI-based collaboration system of claim 13, wherein the plurality of participant personas include a first participant persona, and
the operation of generating the ideas includes:
an operation of generating a primary idea corresponding to the first participant persona in accordance with the second user request;
an operation of generating feedback information by the other participant personas except for the first participant persona with respect to the primary idea; and
an operation of generating a secondary idea corresponding to the first participant persona by reflecting the feedback information in the primary idea.

17. The generative AI-based collaboration system of claim 13, wherein the one or more computer programs further include instructions for:
an operation of evaluating the generated ideas;
an operation selecting an optimal idea based on the evaluated result; and
an operation of visualizing the optimal idea and providing the visualized idea to the user terminal.

18. The generative AI-based collaboration system of claim 17, wherein the operation of evaluating the generated ideas includes:
an operation selecting any one of the plurality of participant personas as an evaluator; and
an operation of grouping the ideas by using the participant persona selected as the evaluator.

19. The generative AI-based collaboration system of claim 17, wherein the operation of evaluating the generated ideas includes:
an operation of generating a user persona representing an end user for a service or product associated with the target problem; and
an operation of grouping the ideas by using the generated user persona.

20. The generative AI-based collaboration system of claim 17, wherein the operation of evaluating the generated ideas includes an operation of performing scoring for the ideas by using the plurality of participant personas.
